(19) United States
(12) Patent Application Publication
(10) Pub. No.: US 2026/0128669 A1
(43) Pub. Date: May 7, 2026

(54) Compensation of Leakage Current in Power Supplies

(71) Applicant: TEXAS INSTRUMENTS INCORPORATED, Dallas, TX (US)

(72) Inventors: Desheng Guo, Shanghai (CN); Sheng-Yang Yu, Frisco, TX (US); Brent McDonald, Murphy, TX (US)

(21) Appl. No.: 18/936,378

(22) Filed: Nov. 4, 2024

(51) Int. Cl. H02M 1/44; H02M 1/42; H02M 7/217

(52) U.S. Cl. CPC H02M 1/44; H02M 1/4208; H02M 7/217

(57) ABSTRACT

A voltage converter may experience leakage current, which is an undesired current that may travel through a current path of the voltage converter and be felt by a human user or sensitive electrical components at a chassis. The voltage converter may be adapted to include a voltage source and an accompanying capacitor to generate a compensating current to compensate for the leakage current.

### TECHNICAL FIELD

The present disclosure relates to power supplies and, more specifically, to power supplies having compensation for leakage currents.

### BACKGROUND

A switch-mode power supply (SMPS) transfers power from an input power source to a load by switching one or more power transistors. The power transistors are coupled through a switch node to an energy storage element (e.g., a capacitor) that is capable of coupling to the load. An SMPS may include an SMPS controller to provide one or more switching (e.g., PWM) control signals to drive the power transistor(s).

### SUMMARY

In an arrangement, a circuit includes: a first switching leg coupled between a first direct current (DC) terminal and a second DC terminal; a second switching leg coupled between the first DC terminal and the second DC terminal; a first switch and a second switch, arranged in the first switching leg, wherein the first switch and the second switch are coupled to a first alternating current (AC) line; a third switch and a fourth switch, arranged in the second switching leg, wherein the third switch and the fourth switch are coupled to a second AC line at a first node of the second switching leg, further wherein the fourth switch is coupled to a ground; and a voltage source, arranged between the ground and the first node of the second switching leg, wherein an output of the voltage source is coupled to a first capacitor.

In an arrangement, a system includes: an alternating current (AC) input having a first AC terminal and a second AC terminal; a first switching leg and a second switching leg coupled between a first direct current (DC) terminal and a second DC terminal, wherein the first switching leg is coupled to the first AC terminal, and wherein the second switching leg is coupled to the second AC terminal; a filter disposed between the AC terminals and the first and second switching legs; a first transistor disposed in the second switching leg between the first DC terminal and a first node; a second transistor disposed in the second switching leg between the first node and the second DC terminal; and a voltage source coupled to the first node and coupled to a ground and having an output coupled to a capacitor.

In an arrangement, a method includes: controlling a voltage converter, including transmitting first control signals to switch a first switching leg at a first frequency and transmitting second control signals to switch a second switching leg at a second frequency that is lower than the first frequency; sensing a first voltage at a first node of the second switching leg; and applying a second voltage to a first capacitor, wherein a value of the second voltage is proportional to a value of the first voltage, thereby injecting a first current to ground via the first capacitor, wherein the first current compensates a second current between the first node and ground.

### BRIEF DESCRIPTION OF THE DRAWINGS

Having thus described the invention in general terms, reference will now be made to the accompanying drawings, wherein:

FIG. 1 is an illustration of an example voltage converter, according to some embodiments;

FIG. 2 is an illustration of various waveforms, which may be present in the system of FIG. 1, according to some embodiments;

FIG. 3 is an illustration of an example voltage converter, adapted according to some embodiments;

FIG. 4 is an illustration of an example voltage converter, adapted according to some embodiments;

FIG. 5 is an illustration of example voltage converter, according to some embodiments;

FIG. 6 is an illustration of example voltage converter, according to some embodiments;

FIG. 7 is an illustration of example voltage converter, according to some embodiments; and

FIG. 8 is an illustration of example method, according to some embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

One example switch mode power supply may include a high-frequency switching leg and a low-frequency switching leg, coupled in parallel between a positive direct current (DC) output terminal and a negative DC output terminal (DC+ and DC− terminals). Furthermore, the negative DC output terminal may be coupled to an earth ground (GND) via a parasitic capacitance. In some instances, there may be a leakage current, which flows from the parasitic capacitance, through a transistor of the low-frequency switching leg, to an alternating current (AC) neutral line, and back to GND at a filter of a switch mode power supply. Leakage current is generally considered to be undesirable. In fact, a leakage current may sometimes be referred to as a touch current, because in some applications it may be conducted through a housing or other piece of the device, which may be touched by human user, where the human user may actually experience a shock from the leakage current. For purposes of illustration, the leakage current is also denoted as Itouch in the disclosure.

Various embodiments compensate for the leakage current by including a compensating voltage source between a node of the low-frequency switching leg and GND. The compensating voltage source is arranged in series with a compensating capacitor to produce a current that is equal in magnitude to the leakage current and opposite in polarity to the leakage current. As the switch mode power supply operates, the compensating voltage source and compensating capacitor may reduce the leakage current to zero or nearly zero.

Such embodiments may provide advantages over other solutions. For instance, such embodiments may allow for wider adoption of some switch mode power supply architectures, which would otherwise be susceptible to leakage current. An example may include a totem pole bridgeless power factor correction rectifier, which may have desirable operating characteristics, such as reduced conduction loss. In other words, such embodiments may allow for wider adoption of totem pole bridgeless power factor correction rectifiers. Furthermore, such embodiments may further improve safety of devices, by further isolating human users and sensitive electrical components from undesired exposure to leakage current.

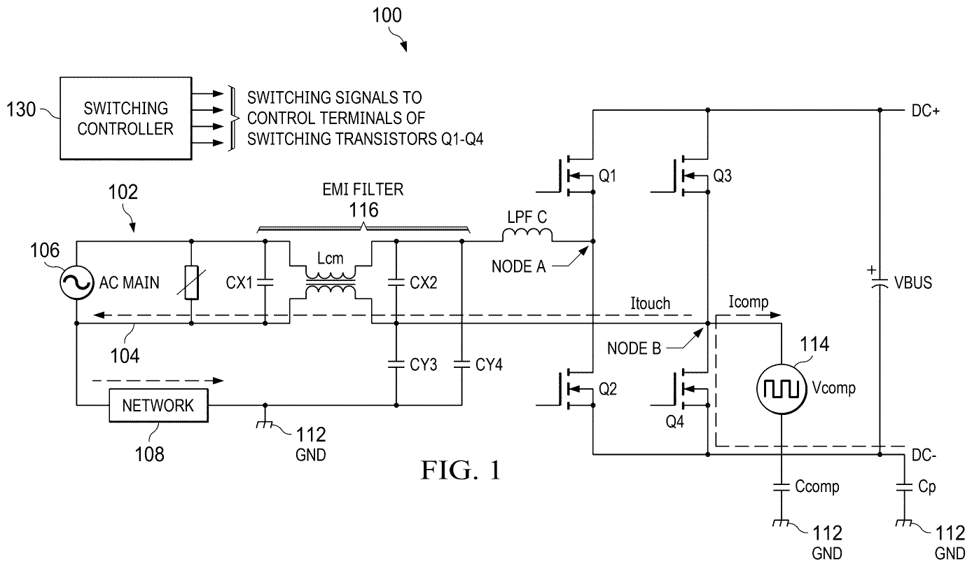

FIG. 1 is an illustration of an example voltage converter 100, according to some embodiments. Voltage converter 100 has an architecture consistent with a totem pole bridgeless power factor correction (PFC) rectifier, receiving an AC voltage from AC voltage source 106 and outputting a DC voltage between the DC+ and DC− terminals. In the present example, the AC power source 106 is coupled to an AC input that includes a first AC line terminal 102 and a second AC line terminal 104. For purposes of illustration, the first and second AC line terminals 102 and 104 will be respectively referred to as AC line terminal 102 and AC neutral terminal 104.

Voltage converter 100 also includes a chassis ground or earth ground, denoted as GND 112. In this context, a chassis refers to a physical structure, such as a conductive enclosure or a conductive portion of an enclosure in which the voltage converter 100 is implemented. The network 108 may be a testing network to measure Itouch, and a designed product may not necessarily include network 108. The GND 112 at network 108 and at filter 116 may represents part of the chassis, which in some instances may have potential exposure to human touch or contact with sensitive electrical components.

The voltage converter 100 also includes parasitic capacitance Cp, which is represented as being coupled between GND 112 and the DC− terminal. The component Lem is an inductor implemented as a common mode choke. The various capacitors CX (e.g., CX1 and CX2) and CY (e.g., CY3 and CY4), along with the inductor Lem, form a passive electromagnetic interference (EMI) filter 116, which is coupled to the AC power source 106 at the AC line terminal 102 and AC neutral terminal 104. The network 108 is coupled between the AC voltage source 106 and GND 112. Further in this example, AC line terminal 102 is coupled to Node A, and AC neutral terminal 104 is coupled to Node B.

In the example of FIG. 1, the capacitor CX1 is coupled between the AC line terminal 102 and the AC neutral terminal 104; the capacitor CX2 is also coupled between the terminals 102 and 104, but at an opposite side of the inductor Lem relative to the capacitor CX1. Capacitor CY3 is coupled between the AC neutral terminal 104 and GND 112; the capacitor CY4 is coupled between the AC line terminal 102 and GND 112 . . . . The filter 116 is coupled to GND 112 via capacitors CY3 and CY4. The CX capacitors are configured to attenuate differential mode noise that appears between terminals 102 and 104. Further in this example, the inductor Lem is implemented as a choke to provide high impedance for common mode noise, such as may be created due to rapid changes in voltage within voltage converter 100. The CY Capacitors may be configured to divert common mode noise to GND 112.

As noted above, the voltage converter 100 is configured to convert the AC input voltage across terminals 102 and 104 to a DC output voltage (VBUS) between DC+ and DC−. In one example, the voltage converter 100 may be implemented as a boost converter to convert an AC input voltage (e.g., 120 V AC or 240 V AC at a frequency of 50 Hz or 60 Hz) to a DC output voltage (e.g., about 400 V DC). In the example of FIG. 1, the voltage converter 100 includes inductor LPFC and an arrangement of transistors Q1, Q2, Q3, and Q4. In this example, inductor LPFC and transistors Q1, Q2, Q3, and Q4 are configured as a totem pole power factor correcting boost AC-DC converter. For example, transistors Q1, Q2, Q3, and Q4 may be implemented as N-type metal oxide semiconductor field effect transistors (NFETs). Alternatively, Q1, Q2, Q3 and Q4 could be implemented as P-type metal oxide semiconductor field effect transistors (PFETs). In still other examples, other types of semiconductor switches could be used including bipolar junction transistors, such as insulated gate bipolar transistors (IGBT), laterally diffused metal oxide semiconductor (LDMOS) transistors, thyristors, GaN devices, a mix of any of the above, or the like.

Transistors Q1 and Q2 are coupled in series between the DC+ and DC− terminals, forming a first switching leg. The DC+ and DC− terminals are adapted to be coupled to a load (not shown) to supply an output DC voltage. For example, the AC line terminal 102 may be coupled to the drain of Q1 and the source of Q2, which are coupled together at a high-frequency switching node (Node A). Transistors Q3 and Q4 may also be coupled in series between the DC+ and DC− outputs, forming a second switching leg. The AC neutral terminal 104 may be coupled to the source of Q3 and the drain of Q4 at a low-frequency switch node (Node B).

Voltage converter 100 also includes switching controller 130, which is configured to provide switching signals to the control terminals of the transistors Q1-Q4. In this example, each of the respective transistors Q1-Q4 receives its own respective switching signal. Each of the switching signals may include, e.g., a pulse width modulation (PWM) control signal configured to cause its respective transistor to open or close.

In the example of FIG. 1, transistors Q1 and Q2 may be configured as high-frequency transistors, and transistors Q3 and Q4 may be configured as low-frequency transistors. Thus, the respective switching signals to transistors Q1 and Q2 may be configured as high-speed switching signals, such as having a frequency greater than 1 KHz (e.g., 10 KHz to 100 KHz or greater). The switching signals to transistors Q3 and Q4 may be configured as low-speed switching signals having the same frequency as the AC input voltage (e.g., 50 Hz or 60 Hz). As a result, the voltage converter 100 may be configured to convert the AC voltage received at terminals 102 and 104 to a corresponding DC output voltage VBUS across output terminals DC+ and DC−.

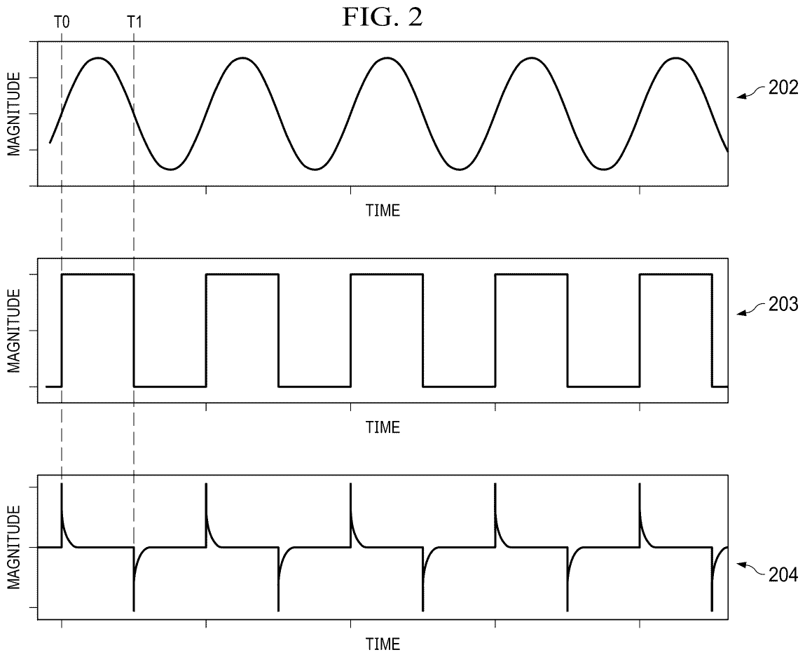

FIG. 2 is an illustration of example waveforms of voltages 202 and 203 and an example current 204, which may be implemented within voltage converter 100, according to some embodiments. In this example, AC voltage 202 may be produced by the AC voltage source 106 across terminals 102 and 104. The AC voltage 202 may be applied across Node A and Node B. As noted above, the parasitic capacitance Cp is illustrated as being disposed between the DC− terminal and GND 112. Voltage 203 represents the voltage across the parasitic capacitance Cp.

According to the totem pole bridgeless PFC operating mechanism, for the entire positive or negative half cycle the voltage across Q4 is either VBUS (DC+ minus DC−) or zero, and Q4 makes transition from ON to OFF or vice versa at the zero crossing of the AC voltage 202. This means that an abrupt change in drain to source voltage of Q4 may exist at the zero crossing, and an amplitude of this change is equal to VBUS in a very short time. Such phenomenon may cause a sudden voltage change across Cp, which results in current flow through Q4 due to the low impedance path “GND-Cp-Q4-Lcm-network-GND”. This is the leakage current, and it is labeled “Itouch” in FIG. 1 and shown as current 204 in FIG. 2. Charge and discharge of Cp is done through Q4 as per Equation (1), and the peak value (iₚ) of a current spike of Itouch is proportional to the capacitance value of Cp in addition to the slew rate of Q4.

$${i}_{P} = Cp \times \frac{{d V}_{Cp}}{dt} \qquad Eq . ( 1 )$$

Note in FIG. 2 that a first current spike is shown at time TO, which corresponds with a zero crossing of the AC voltage 202, and a second current spike is shown at time T1, which corresponds with the next subsequent zero crossing of the AC voltage 202. The spike at time TO is positive, whereas the spike at time T1 is negative, and that repeats with every cycle of the AC voltage 202.

Further to be noted is that Itouch is shown in FIG. 1 as having a direction, but that is only one defined direction, and as shown in FIG. 2, Itouch is sometimes positive and sometimes negative.

Various embodiments compensate for the leakage current Itouch by including compensating voltage source 114. In this example, compensating voltage source 114 is coupled between Node B and GND 112. A compensating capacitor Ccomp is coupled between the compensating voltage source 114 and GND 112. The compensating capacitor Ccomp is disposed between the compensating voltage source 114 and GND 112 to cause a compensating current Icomp that is approximately equal in magnitude to Itouch and opposite in polarity to Itouch at a given instance in time. Put another way, the compensating current Icomp should be approximately equal in magnitude to the waveform of current 204 and opposite in polarity at a given time. Thus, at time T0, the compensating current Icomp should be negative, and at time T1, the compensating current Icomp should be positive.

In some examples, the compensating voltage source 114 may be configured to sense an appropriate voltage as an input to generate a voltage output that is proportional to the voltage across Q4 in magnitude. Furthermore, the size of the compensating capacitor Ccomp may be determined using Equation 2, where Δt is the transition time of the low-frequency switching leg having Q2 and Q4, and ΔV is the difference in voltage between Node B and the DC− terminal. As a result, the compensating current Icomp may zero out or at least reduce the leakage current Itouch, at least seen at the network 108.

$$Ccomp \times \frac{{ΔV}_{Ccomp}}{Δ t} = Cp \times \frac{{ΔV}_{Cp}}{Δ t} \qquad Eq . ( 2 )$$

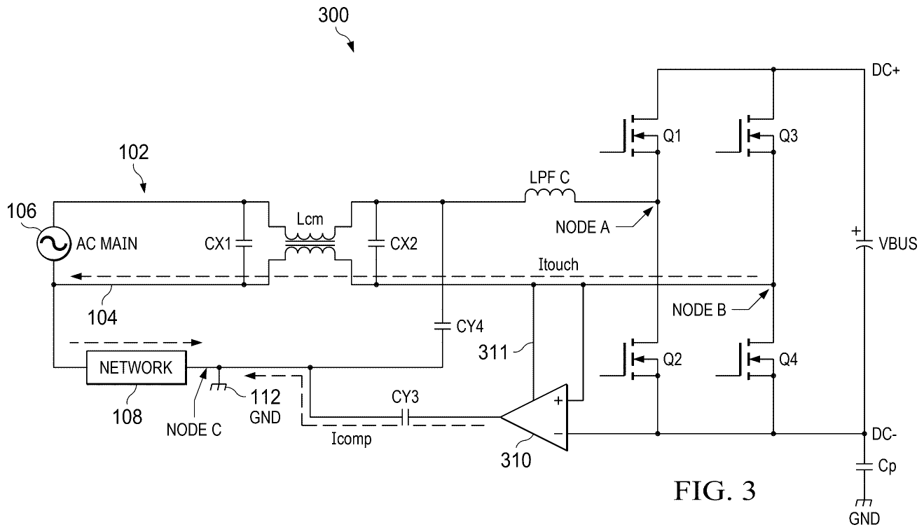

FIG. 3 is an illustration of an example voltage converter 300, adapted according to some embodiments. Voltage converter 300 is similar to the voltage converter 100 of FIG. 1, as both are totem pole bridgeless power factor correction rectifiers. One difference between voltage converter 300 and voltage converter 100 is that voltage converter 300 moves capacitor CY3 out of the filter 116 and uses CY3 as a compensating capacitor (shown as Ccomp in FIG. 1). Please note that FIG. 3 is provided only as an example for purposes of illustration. In some embodiments, voltage converter 300 may still keep the capacitor CY3 (as shown in FIG. 1) and use a separate capacitor Cp as the compensating capacitor. CY3 may be sized according to Equation 2.

Voltage converter 300 employs operational amplifier (op amp) 310 as a compensating voltage source, such as discussed above with respect to compensating voltage source 114. Op amp 310 has a non-inverting (+) input, which is connected to the AC neutral terminal 104 at Node B and an inverting (−) input coupled to the DC− terminal. Furthermore, op amp 310 has an internal ground reference 311, which is coupled to the AC neutral terminal 104. The ground reference 311 may provide a reference point for the output voltage of the op amp 310. Additionally, the ground reference 311 may serve as a return for the compensating current Icomp. The output of op amp 310 is coupled to Node C (GND 112 at the filter 116) via capacitor CY3. Put another way, the capacitor CY3 is disposed in series between the output of op amp 310 and Node C.

The op amp 310 senses the voltage difference between Node B and the DC− terminal, and it has an internal ground reference 311 coupled to Node B. As a result, the op amp 310 outputs a voltage that is proportional to the voltage across transistor Q4 and is a same polarity as the voltage across transistor Q4 from drain to source. The capacitor CY3 is configured to charge and discharge, thereby producing compensating current Icomp. Compensating current Icomp is approximately the same magnitude as Itouch and has an opposite polarity as Itouch, thereby eliminating or at least reducing Icomp.

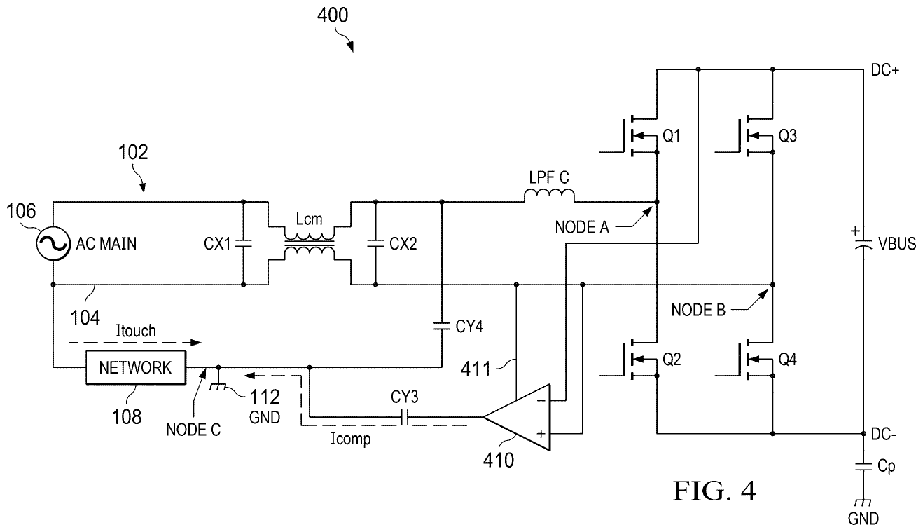

FIG. 4 is an illustration of an example voltage converter 400, adapted according to some embodiments. Voltage converter 400 is configured as a totem pole bridgeless power factor correction rectifier, similar to the voltage converters 100 and 300 discussed above. Similar to the voltage converter 300, voltage converter 400 moves capacitor CY3 out of the filter 116 and uses CY3 as a compensating capacitor (e.g., Ccomp). CY3 may be sized as a compensating capacitor according to Equation 2.

Operational amplifier 410 functions similarly to the compensating voltage source 114 of FIG. 1. In this example, op amp 410 includes a non-inverting input coupled to the AC neutral terminal 104 (Node B) and an-inverting input coupled to the DC+ terminal. The ground reference 411 is coupled to the AC neutral terminal 104. Similarly, the ground reference 411 may provide a reference point for the output voltage of the op amp 410. Additionally, the ground reference 411 may serve as a return for the compensating current Icomp. The output of the op amp 410 is coupled to Node C (GND 112 at the filter 116) via capacitor CY3. Thus, capacitor CY3 is disposed in series between the output of op amp 410 and Node C. The op amp 410 senses the voltage across transistor Q3, which is disposed in the low-frequency switching leg with transistor Q4. In this example, the voltage across transistor Q3 is proportional to the voltage across transistor Q4, and in an example in which transistor Q3 is a same size as transistor Q4, the voltage across transistor Q3 would be expected to be a same magnitude as the voltage across Q4 and opposite in polarity to the voltage across Q4 (drain to source). The arrangement of the inverting and non-inverting inputs of the op amp 410 results in the output voltage of the op amp 410 being proportional to the voltage across Q4 and the same polarity as the voltage across Q4.

The output voltage of the op amp 410 charges and discharges capacitor CY3, resulting in a compensating current Icomp that is approximately equal in magnitude and opposite in polarity of the leakage current Itouch.

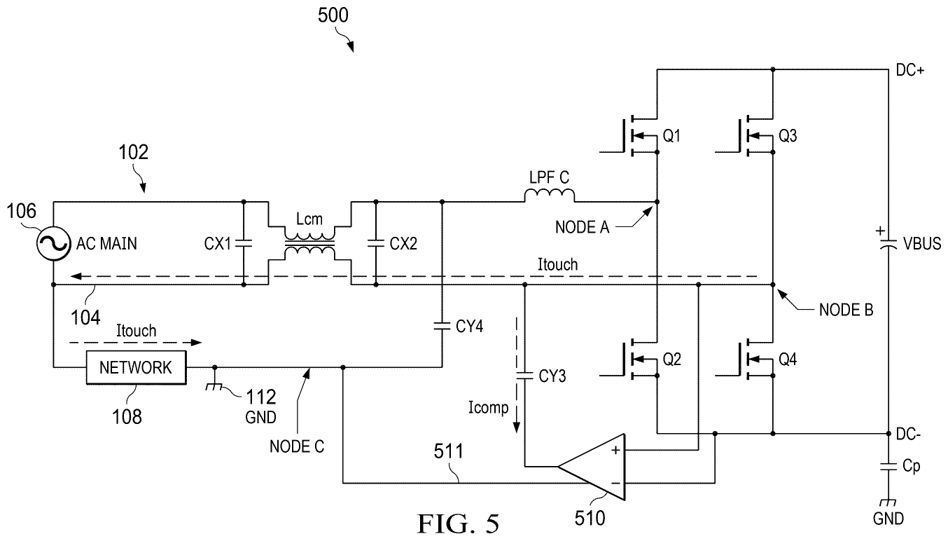

FIG. 5 is an illustration of example voltage converter 500, according to some embodiments. Voltage converter 500 is a totem pole bridgeless power factor correction rectifier, and it moves capacitor CY3 from the filter and uses it as a compensation capacitor, such as Ccomp of FIG. 1. In other words, the size of CY3 may be determined using Equation 2.

Op amp 510 is configured to produce an output voltage that is proportional to the voltage across transistor Q4 and is opposite in polarity to the voltage across transistor Q4. The inverting input of op amp 510 is coupled to Node B at the AC neutral terminal 104. The noninverting input of op amp 510 is coupled to the DC− terminal. The ground reference 511 is coupled to Node C (GND 112). The ground reference 511 may provide a reference point for the output voltage of the op amp 510. Additionally, the ground reference 511 may serve a return for the compensating current Icomp.

The capacitor CY3 is coupled between the output of op amp 510 and Node B. In this example, the output voltage of op amp 510 charges and discharges capacitor CY3, which results in a compensating current Icomp injected at Node B. The compensating current Icomp is approximately equal in magnitude and opposite in polarity to the leakage current Itouch.

Thus, the examples of FIGS. 3-5 employ respective op amps 310, 410, 510 as compensating voltage sources and use capacitor CY3 to generate a compensating current Icomp. The op amps 310, 410, 510 are each arranged so as to be coupled to Node B and GND 112 at Node C, though each of the arrangements are different. In all three cases, the voltage converters 300-500 use their respective op amps 310, 410, 510 to inject compensating current Icomp to cancel out or approximately cancel out the leakage current Itouch, at least seen at the network 108. In some implementations, each of the respective op amps 310, 410, 510 may be configured for unity gain, though various implementations may use any appropriate gain configuration.

The scope of implementations is not limited to using op amps as compensating voltage sources. Rather, other implementations may use any appropriate compensating voltage source, such as a transformer or other component.

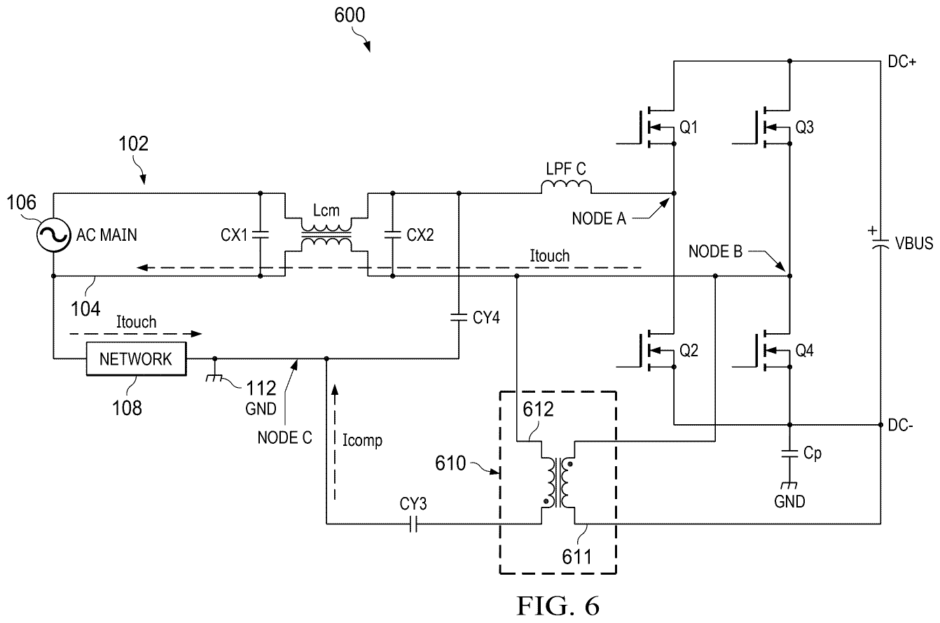

FIG. 6 is an illustration of example voltage converter 600, according to some embodiments. Voltage converter 600 is a totem pole bridgeless power factor correction rectifier, and it uses transformer 610 as a compensating voltage source, such as with compensating voltage source 114 of FIG. 1. Once again, capacitor CY3 has been moved out of the filter and is used as a compensating capacitor, such as discussed above with Ccomp in FIG. 1. The size of capacitor CY3 may be determined using Equation 2.

Transformer 610 includes a primary winding 611 and a secondary winding 612. The windings 611 and 612 have opposite polarities, as indicated by their respective phase dots. Primary winding 611 is coupled between Node B and the DC− terminal. The secondary winding 612 is coupled between Node B and Node C (GND 112 at the filter 116).

The primary winding 611 is configured to sense the voltage across transistor Q4 and, thus, the secondary winding 612 is configured to generate a voltage proportional in magnitude and opposite in polarity to the voltage across transistor Q4.

As a result, capacitor CY3 charges and discharges to produce compensating current Icomp. The respective number of turns in each of windings 611 and 612 may be configured so that the compensating current Icomp is approximately equal in magnitude and opposite in polarity to the leakage current Itouch.

The transformer 610 may be configured in any appropriate way, such as having any appropriate number of turns in the respective winding 611 612. Further, although not shown here, the primary winding 611 may also include a DC-blocking capacitor to ensure proper biasing of the transformer 610. For instance, the DC-blocking capacitor may be one or more orders of magnitude larger than the compensating capacitor CY3, though the scope of embodiments may include any appropriately sized DC-blocking capacitor. Furthermore, although not shown here, the primary winding 611 may also generate some current between Node B and the DC− terminal, though such current would not be expected to affect the leakage current Itouch because the current path through the primary winding 611 goes through Q3 and is not coupled to GND 112 (other than through Cp).

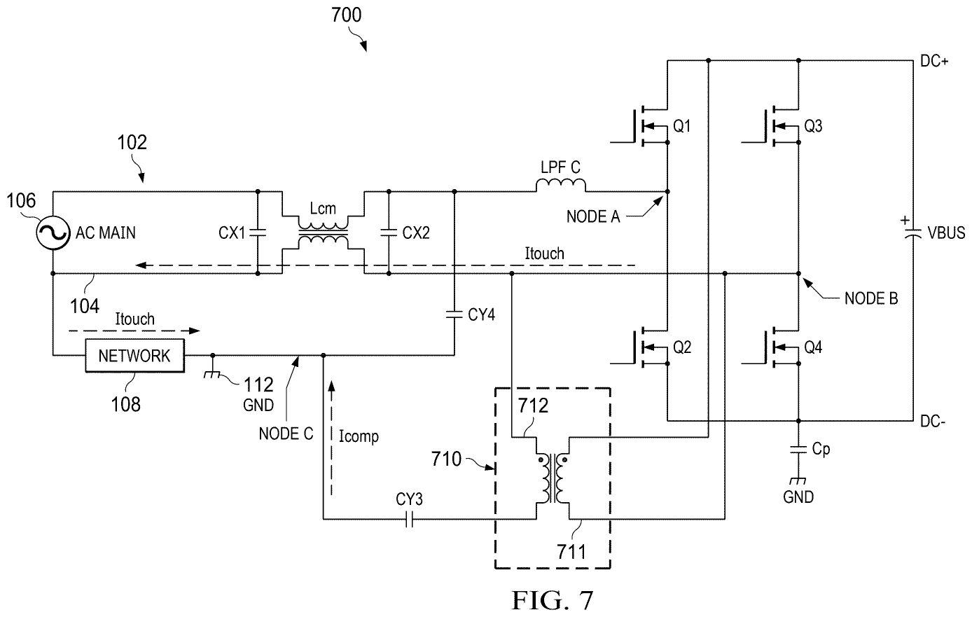

FIG. 7 is an illustration of example voltage converter 700, according to some embodiments. Voltage converter 700 may be implemented similarly to voltage converter 600, though with some illustrated changes.

For instance, transformer 710 has a primary winding that is coupled between Node B and the DC+ terminal. In some examples in which transistor Q3 and transistor Q4 are the same size, the primary winding 711 would be expected to experience a voltage that is the same in magnitude but opposite in polarity to the voltage across transistor Q4. Furthermore, primary winding 711 and secondary winding 712 have a same polarity, as indicated by the phase dots.

Secondary winding 712 is coupled between Node B and Node C (GND 112 at the filter 116). The compensating voltage generated by the secondary winding 712 may be proportional in magnitude and opposite in polarity to the voltage across transistor Q4. As a result, the compensating capacitor CY3 charges and discharges to produce Icomp, which is approximately the same in magnitude and opposite in polarity to the leakage current Itouch.

Both of the implementations of FIGS. 6-7 use a transformer as a compensating voltage source. The transformer is coupled between GND 112 at the filter and the AC neutral line (Node B), though the particular coupling arrangements are different in each of the two implementations.

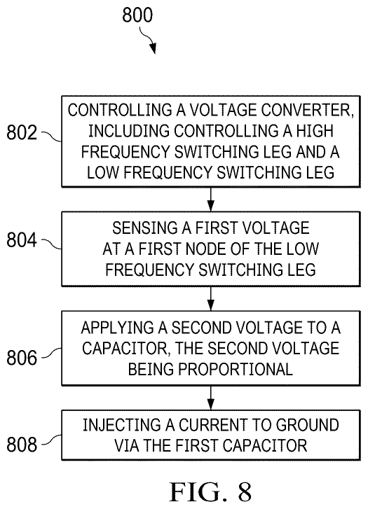

FIG. 8 is an illustration of example method 800, according to some embodiments. Method 800 may be performed by a voltage converter, such as those described above with respect to FIGS. 1-7.

Action 802 includes controlling a voltage converter. Examples of voltage converters are illustrated above at FIGS. 1 and 3-7. Controlling voltage converters may include using a switching controller, such as switching controller 130 of FIG. 1 to control the switches of the switching converter. Each of the different switching converters of FIGS. 1 and 3-7 include four transistors Q1-Q4, which are operated as switches according to the switching signals from the switching controller 130.

For example, the transistors Q1 and Q2 may be arranged as a high-frequency switching leg, with the transistors Q1 and Q2 disposed between the DC+ and the DC− terminals, with a node (Node A) between the transistors Q1 and Q2 being coupled to an AC line terminal. Each of the transistors Q1 and Q2 may receive a respective switching signal from the switching controller 130, switching each of the transistors Q1 and Q2 ON and OFF according to a pattern appropriate for a totem pole bridgeless power factor correction rectifier.

Similarly, the transistors Q3 and Q4 may be arranged as a low-frequency switching leg, with the transistors Q3 and Q4 disposed between the DC+ and DC− terminals. A node (Node B) between the transistors Q3 and Q4 may be coupled to an AC neutral terminal. Each of the transistors Q3 and Q4 may receive a respective switching signal from the switching controller 130, switching each of the transistors Q3 and Q4 ON and OFF according to a pattern appropriate for a total bridgeless power factor correction rectifier. Thus, the transistors Q1-Q4 act as switches under control of the switching controller 130.

Further in this example, the transistor Q4 may be arranged so that it is coupled to GND 112 through a parasitic capacitance Cp. In one example, the parasitic capacitance Cp may represent a capacitance associated with a current path of a leakage current, such as the path of Itouch. The path may originate at GND 112 at the DC− terminal and traverse through the transistor Q4, the filter 116 and inductor Lem, over the AC neutral line 104, through the network 108 and to the GND 112 at a node of the filter 116. Further in this example, turning transistor Q4 ON and OFF may result in a repeating leakage current, illustrated as Itouch and current 204.

At action 804, the voltage converter senses a first voltage at a first node of the low-frequency switching leg. For instance, the first node of the low-frequency switching leg may include Node B, which is the node between transistors Q3 and Q4, where transistors Q3 and Q4 are coupled to the AC neutral terminal 104.

Action 804 may include the voltage being sensed by a device acting as a compensating voltage source. In the example of FIG. 3, op amp 310 senses the voltage across transistor Q4 and uses the AC neutral terminal 104 as a ground reference. In the example of FIG. 4, op amp 410 senses the voltage across transistor Q3 and uses the AC neutral terminal 104 as a ground reference. In the example of FIG. 5, op amp 510 senses the voltage across transistor Q4 and uses GND 112 as a ground reference. In the example of FIG. 6, transformer 610 senses the voltage across transistor Q4 by primary winding 611, and in the example of FIG. 7, transistor 610 senses the voltage across transistor Q3 by primary winding 711.

Action 806 includes applying a second voltage to a first capacitor, where the second voltage is proportional to the first voltage in magnitude. In the example of FIG. 3, the op amp 310 generates the second voltage at its output. In the example of FIG. 4, the op amp 410 generates the second voltage at its output, and in FIG. 5, the op amp 510 generates the second voltage at its output. In each of the op amp examples of FIGS. 3-5, the capacitor CY3 in series with the op amp output and is used as a compensation capacitor (Ccomp), and the size of CY3 may be determined using Equation 2. In the examples of FIGS. 6 and 7, respective transformers 610 and 710 generate the voltage on their secondary windings 612 and 712 having a polarity that is opposite that of a drain to source voltage across transistor Q4. Once again, CY3 is a compensating capacitor that may be sized using Equation 2.

At action 808, the voltage converter injects a current to ground via the first capacitor. In each of the examples of FIGS. 1 and 3-7, the current is shown as compensating current Icomp, and it is approximately equal to the leakage current Itouch in magnitude and opposite in polarity. In other words, the injected current compensates a leakage current that flows through the first node (Node B) to ground.

Furthermore, as time progresses, the voltage sensed at action 804 may go from positive to negative and back, and the leakage current may go from a positive peak to a negative peak and back, and on and on, as depicted by current 204 of FIG. 2. Thus, the current injected at action 808 may also go from negative to positive and back, and at each instance of time be opposite in polarity to the leakage current depicted as current 204 of FIG. 2. As a result, the compensating current Icomp may zero out or at least reduce the leakage current Itouch, at least seen at the network 108.

Although not specifically illustrated in FIGS. 1 and 3-7, the various components may be implemented using any appropriate technology. In one example, the various components of the voltage converters may be implemented on a substrate, such as a printed circuit board, having metal wires in various layers of the printed circuit board. The various capacitors and inductors may be mounted to the printed circuit board and connected by the wires. The transistors Q1-Q4 may be implemented on one or more semiconductor dies, where those one or more semiconductor dies may be mounted to the printed circuit board and the metal wires of the printed circuit board. However, other manufacturing technologies, appropriate for a given use case, may be used as appropriate.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A circuit comprising:
a first switching leg coupled between a first direct current (DC) terminal and a second DC terminal;
a second switching leg coupled between the first DC terminal and the second DC terminal;
a first switch and a second switch, arranged in the first switching leg, wherein the first switch and the second switch are coupled to a first alternating current (AC) line;
a third switch and a fourth switch, arranged in the second switching leg, wherein the third switch and the fourth switch are coupled to a second AC line at a first node of the second switching leg, further wherein the fourth switch is coupled to a ground; and
a voltage source, arranged between the ground and the first node of the second switching leg, wherein an output of the voltage source is coupled to a first capacitor.

2. The circuit of claim 1, wherein the voltage source is configured to produce a first voltage that is proportional and opposite in polarity to a second voltage across the fourth transistor.

3. The circuit of claim 1, wherein the voltage source comprises:
an operational amplifier having an inverting input and a non-inverting input, wherein the non-inverting input is coupled to the first node of the second switching leg, and wherein the inverting input is coupled to the second DC terminal, further wherein an output of the amplifier is coupled to the ground via the first capacitor.

4. The circuit of claim 1, wherein the voltage source comprises:
an operational amplifier having an inverting input and a non-inverting input, wherein the non-inverting input is coupled to the first node of the second switching leg, and wherein the inverting input is coupled to the first DC terminal, further wherein an output of the amplifier is coupled to the ground via the first capacitor.

5. The circuit of claim 1, wherein the voltage source comprises:
an operational amplifier having an inverting input and a non-inverting input, wherein the inverting input is coupled to the first node of the second switching leg, and wherein the non-inverting input is coupled to the second DC terminal, further wherein an output of the amplifier is coupled to the first node of the second leg via the first capacitor.

6. The circuit of claim 1, wherein the voltage source comprises:
a transformer having a first winding and a second winding, wherein the first winding is coupled to the second AC line and coupled to the ground via the first capacitor.

7. The circuit of claim 6, wherein the second winding is coupled to the first node of the second leg and to the second DC terminal.

8. The circuit of claim 7, wherein the first winding and the second winding have different polarities.

9. The circuit of claim 6, wherein the second winding is coupled to the first DC terminal and the first node of the second leg, and wherein the first winding and the second winding have a same polarity.

10. A system comprising:
an alternating current (AC) input having a first AC terminal and a second AC terminal;
a first switching leg and a second switching leg coupled between a first direct current (DC) terminal and a second DC terminal, wherein the first switching leg is coupled to the first AC terminal, and wherein the second switching leg is coupled to the second AC terminal;
a filter disposed between the AC input and the first and second switching legs;
a first transistor disposed in the second switching leg between the first DC terminal and a first node;
a second transistor disposed in the second switching leg between the first node and the second DC terminal; and
a voltage source coupled to the first node and coupled to a ground and having an output coupled to a capacitor.

11. The system of claim 10,
wherein the voltage source comprises an operational amplifier having a first input coupled to the second DC terminal and a second input coupled to the first node, wherein an output of the operational amplifier is coupled to the ground via the capacitor.

12. The system of claim 10, wherein the voltage source comprises an operational amplifier having a first input coupled to the first DC terminal and a second input coupled to the first node, wherein an output of the operational amplifier is coupled to the ground via the capacitor.

13. The system of claim 10, wherein the voltage source comprises an operational amplifier having a first input coupled to the second DC terminal and a second input coupled to the first node, wherein an output of the operational amplifier is coupled to the first node via the capacitor.

14. The system of claim 10, wherein the voltage source comprises a transformer having a first winding coupled to the first node and to the ground via the capacitor.

15. The system of claim 14, wherein the voltage source comprises a second winding coupled to the first node and to the second DC terminal.

16. The system of claim 14, wherein the voltage source comprises a second winding coupled to the first DC terminal and the first node.

17. The system of claim 14, wherein the voltage source comprises a second winding coupled to the first node and to the second DC terminal, and wherein the first winding has an opposite polarity relative to the second winding.

18. The system of claim 14, comprising a totem pole bridgeless power factor correction rectifier that includes the first switching leg and the second switching leg.

19. A method comprising:
controlling a voltage converter, including transmitting first control signals to switch a first switching leg at a first frequency and transmitting second control signals to switch a second switching leg at a second frequency that is lower than the first frequency;
sensing a first voltage at a first node of the second switching leg; and
applying a second voltage to a first capacitor, wherein a value of the second voltage is proportional to a value of the first voltage, thereby injecting a first current to ground via the first capacitor, wherein the first current compensates a second current between the first node and ground.

20. The method of claim 19, wherein the first voltage comprises a voltage between the first node and a positive direct current (DC) terminal of the voltage converter or a voltage between the first node and a negative DC terminal of the voltage converter, and wherein the ground is an earth ground or a chassis ground.
